(19) United States
(12) Patent Application Publication
(10) Pub. No.: US 2026/0077635 A1
(43) Pub. Date: Mar. 19, 2026

(54) Jeep Door Frame Cover

(71) Applicant: Brian Goldwitz, WATERBURY, CT (US)

(72) Inventor: Brian Goldwitz, WATERBURY, CT (US)

(21) Appl. No.: 19/334,774

(22) Filed: Sep. 19, 2025

Related U.S. Application Data
(60) Provisional application No. 63/696,499, filed on Sep. 19, 2024.

(51) Int. Cl. B60J 5/04

(52) U.S. Cl. CPC B60J 5/0415; B60J 5/045

(57) ABSTRACT

A removable jeep door frame with a removable cover that is removed and placed on the inside of the door frame. This is an improvement that cover can be removed while the jeep is moving without danger of it falling out and injuring anyone or causing damage. The cover can be a net, molle panel or solid panel. Multiple covers can be used.

### CROSS-REFERENCES TO RELATED APPLICATIONS (IF ANY)

This application claims the priority date of Provisional Application 63/696,499 filed on Sep. 19, 2025.

### TECHNICAL FIELD

The technology discussed below relates vehicle accessories mainly door frames and door frame covers.

### BACKGROUND

The changes in technology and needed functionality with vehicles. This is especially true with vehicle like jeeps and SUVs. Owners like the option of removing the fixed doors allowing for an open air felling. Sometimes it is good to have panels.

### SUMMARY

The current invention is a jeep door frame with a set of covers on the inside and/or outside. The panels are design to be easily installed and removed with a frame. The covers can be partial or full cover or the cover may been netted or with a plurality of holes.

These are improvements over the current art.

### DESCRIPTION OF THE FIGURES

FIG. 1 shows a jeep door frame without the cover.

FIG. 2 shows a jeep door cover.

FIG. 3 shows a jeep door frame with the cover on the inside.

FIG. 4 shows a jeep door frame with a netted cover.

FIG. 5 shows a jeep door frame with no cover.

FIG. 6 shows a jeep door frame connected to a wind shield.

FIG. 7 shows the latch of the door frame.

FIG. 8 shows a close up view of the latch.

FIG. 9 shows a door frame in a vehicle.

FIG. 10 shows a door frame in the front seat and back seat.

FIG. 11 shows a door frame with a netted type cover.

FIG. 12 shows another view of a door frame with a netted type cover.

FIG. 13 shows a door frame with a solid cover.

FIG. 14 shows a door frame with a mirror attached.

FIG. 15 shows a door frame with a mirror with a partial netted cover.

FIG. 16 shows a door frame with a mirror with a single netted cover.

FIG. 17 shows a door frame with a mirror with a bottom netted cover.

FIG. 18 shows a door frame with a mirror with a netted cover.

FIG. 19 shows a molle or netted cover.

FIG. 20 shows a solid cover.

FIG. 21 show a door frame with a top molle panel.

FIG. 22 shows a door frame with and without a bottom molle panel.

FIG. 23 shows the inside view of a door frame.

FIG. 24 shows the outside view of a door frame.

FIG. 25 shows molle panels.

FIG. 26 shows solid panels.

### DETAILED DESCRIPTION

The illustrations presented herein are, in some instances, not actual views of any particular framing devices or components thereof but may be idealized representations which are employed to describe the present disclosure. Additionally, elements common between figures may retain the same numerical designation.

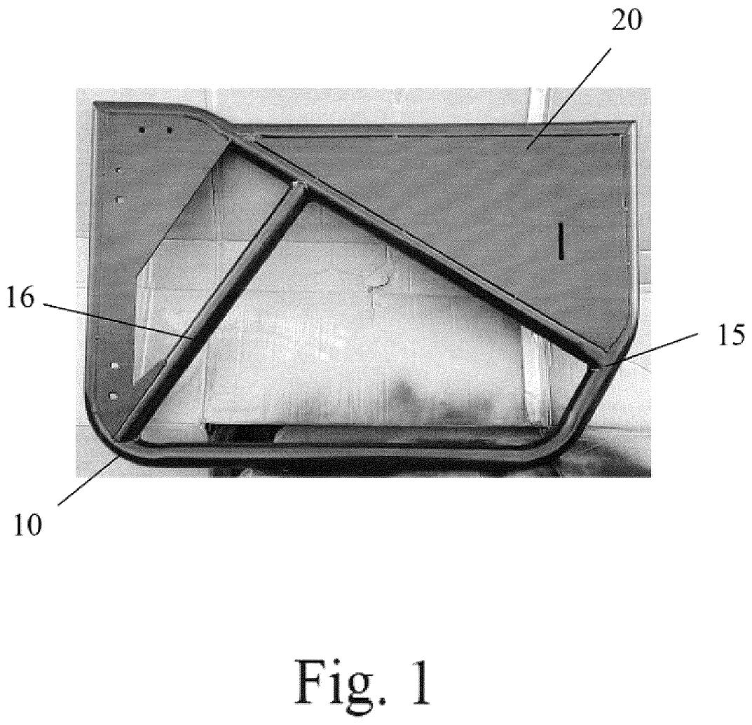

The current invention is a jeep door cover 20 of door frames 15 with FIGS. 1 through 26 showing the jeep door frame and door frame cover embodiments.

FIG. 1 shows a removable jeep door frame 10 with a partial cover 20. The jeep door frame 10 will have an outer frame 15 with support bars 16 that connect one side of the outer door frame 10 to another or as shown in FIG. 1 from the other frame 15 to another support bar 16. FIG. 1 shows a partial cover 20. The door frame 10 shape and size depends on the desires of the vehicle owner and the style of the vehicle 100. In the preferred embodiment the frame 10 will be framed of cylindric, rounded pieces/tubes.

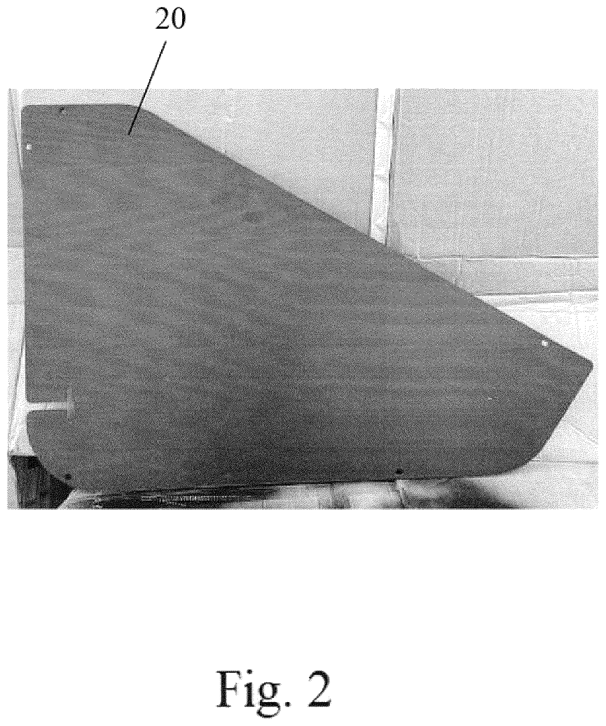

FIG. 2 shows a jeep door cover panel 20 which can be placed on the outside or inside of the door frame 10. The cover panels 20 can be made of a flat sturdy material such as metal or a strong plastic or similar material. They can also be formed of netted materials or molle panels as shown in the Figures.

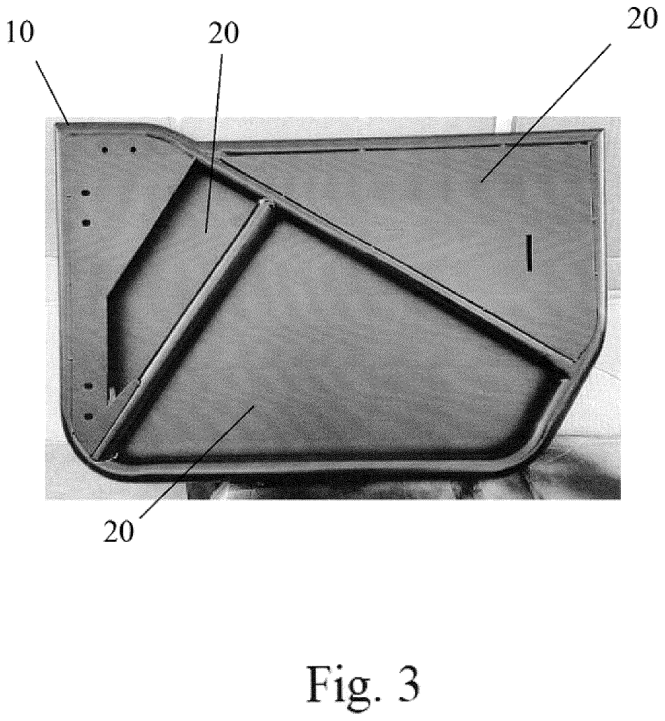

FIG. 3 shows a jeep door frame 10 with a full cover 20 on the inside. The cover 20 can be on the inside or outside of the door cover panel.

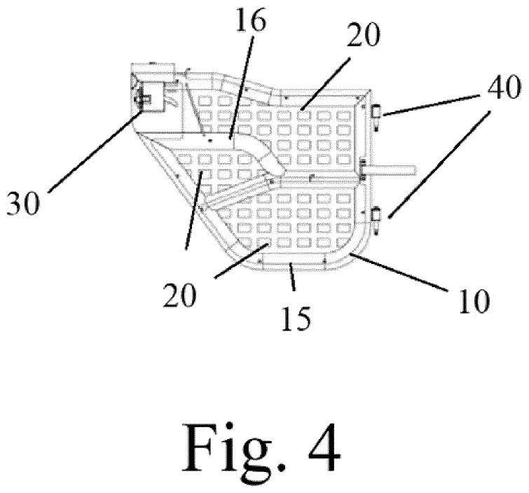

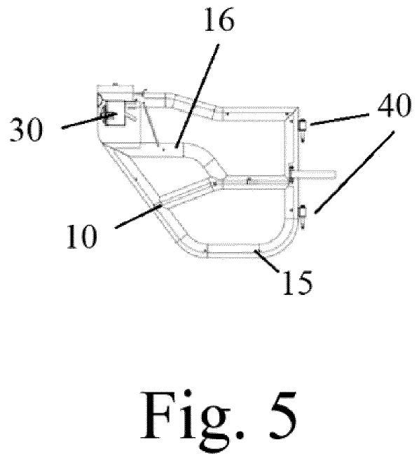

FIG. 4 shows a jeep door frame 10 with a netted cover 20, a molle panel can also be used. The door frame 10 has a pair of pins 40 on the front outer frame which are positioned to go into the door hinges 90 of the vehicle 100. On the back side of the door frame 20 this is a latch 30 that latches the door frame to the vehicle 100 using the vehicle door latch 30. FIG. 5 shows the door frame 10 without a cover 20 with the pins 40 and the latch 30.

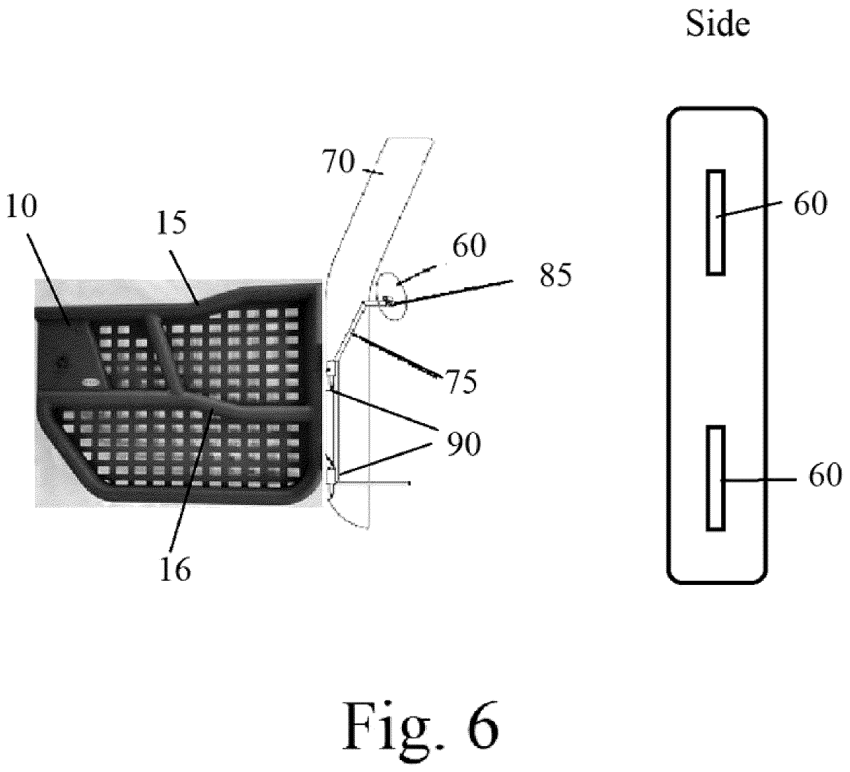

The door frame 10 may have slots 21 or holes for bolts, pins and nuts 25 in the outer frame 16 where accessories can be attached. FIG. 6 shows a jeep door frame 10 connected to a wind shield 70. Other similar accessories can be attached to the door frame. The wind shield 70 angles wind away from the cab of the vehicle 100. It can have a mirror 60 with a rotating connection 85 and a wind shield support bar 75. The door frame 10 will connect to the vehicle 100 by having the pins 40 are placed into the vehicle hinges 90.

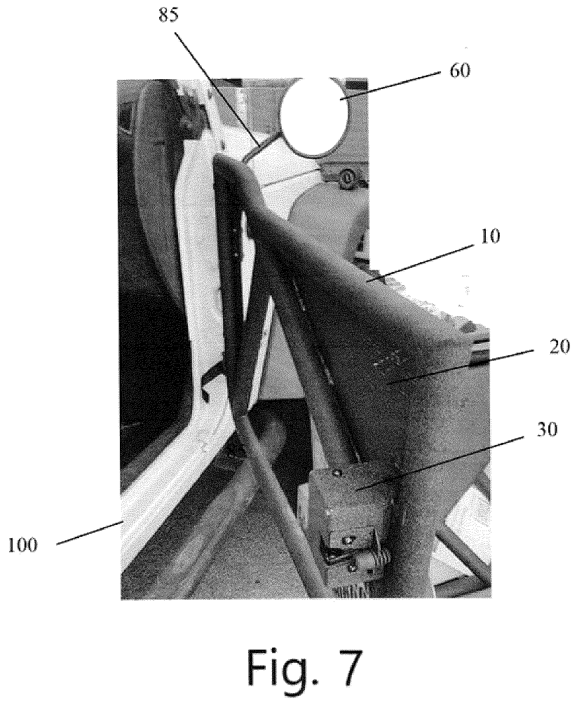

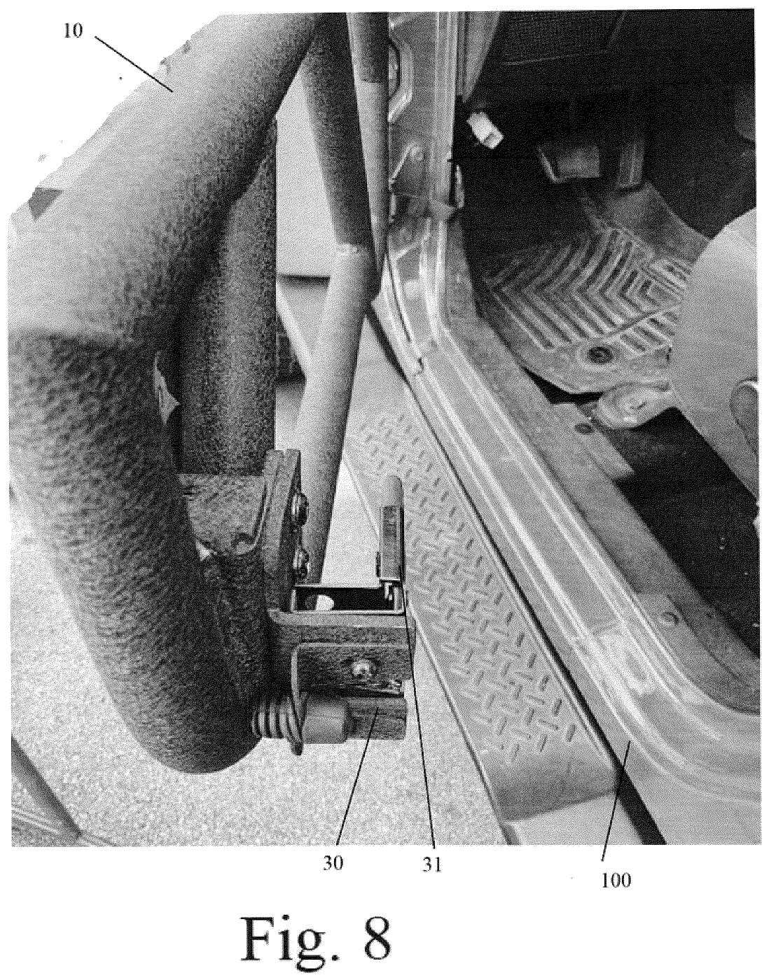

FIGS. 7 and 8 show the door frame latch 30 which latched on the vehicle door latch to close the door frame 10. FIG. 8 shows a close-up view of the latch 30. The latch 30 will have a level or handle 31 that can be pulled down or turned to release the door frame 10 allowing the door frame 10 to open while pivoting on the pins 40.

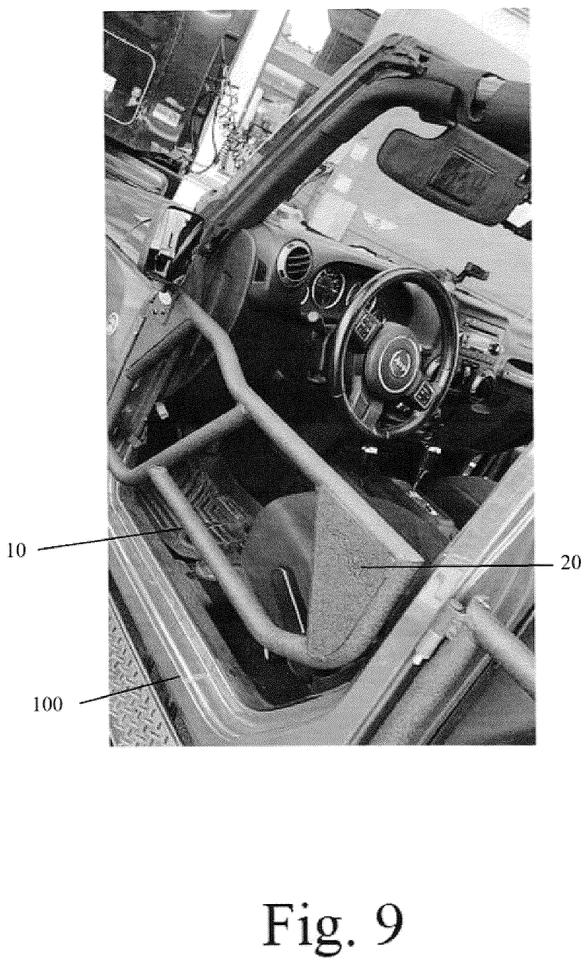

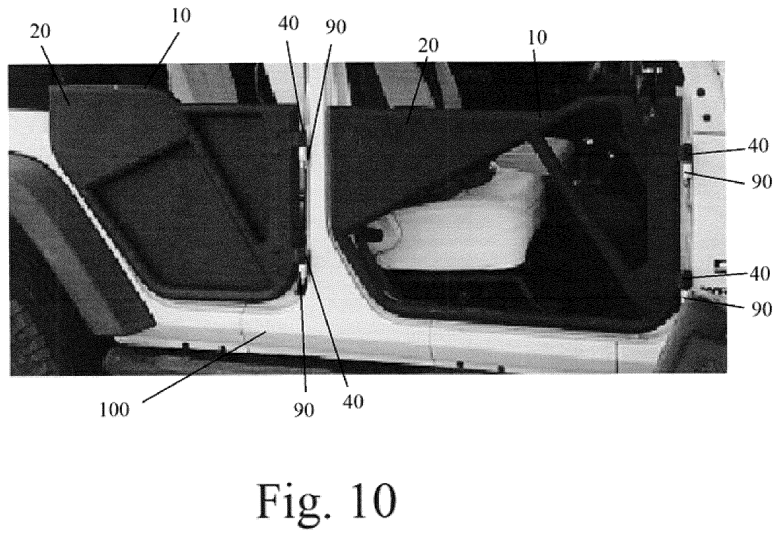

FIG. 9 shows a door frame 10 with a partial cover 20 in a vehicle 100 while FIG. 10 shows a door frame 10 in the front seat and back seat. In FIG. 10, the front door frame 10 has a partial cover 20 while the back as a full cover 20.

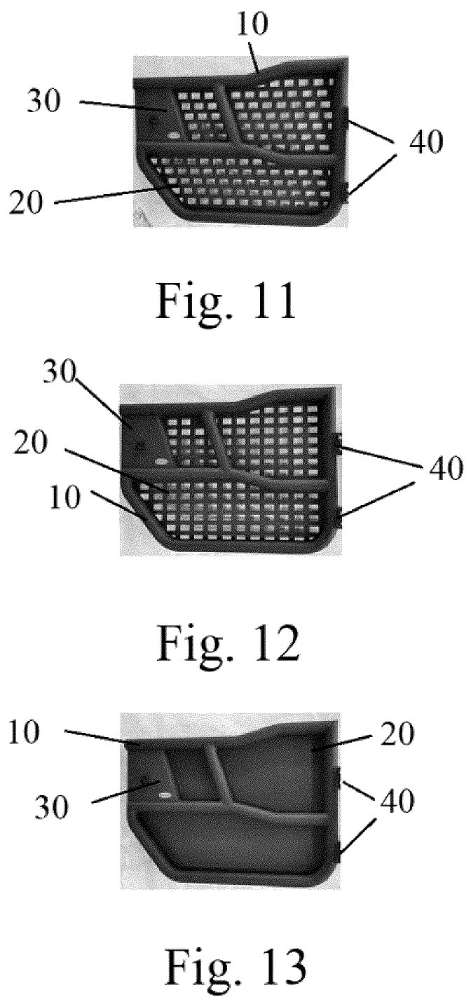

FIGS. 11 and 12 show the door frame 10 with a net panel 20 while FIG. 13 shows the door frame 10 with a solid panel 20.

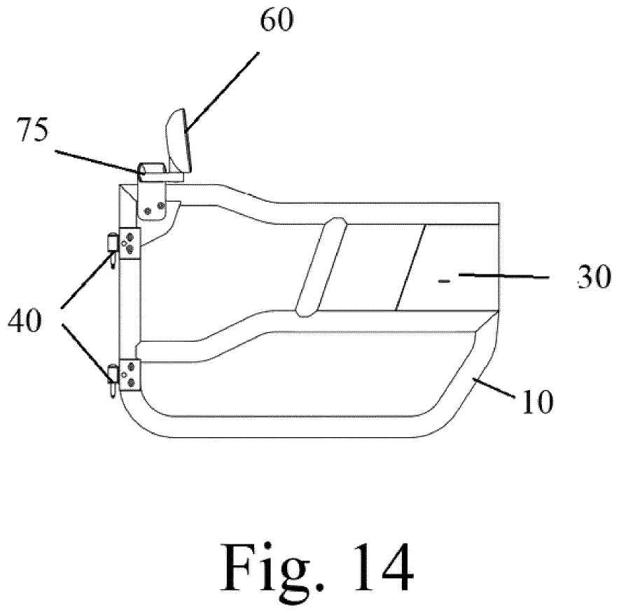

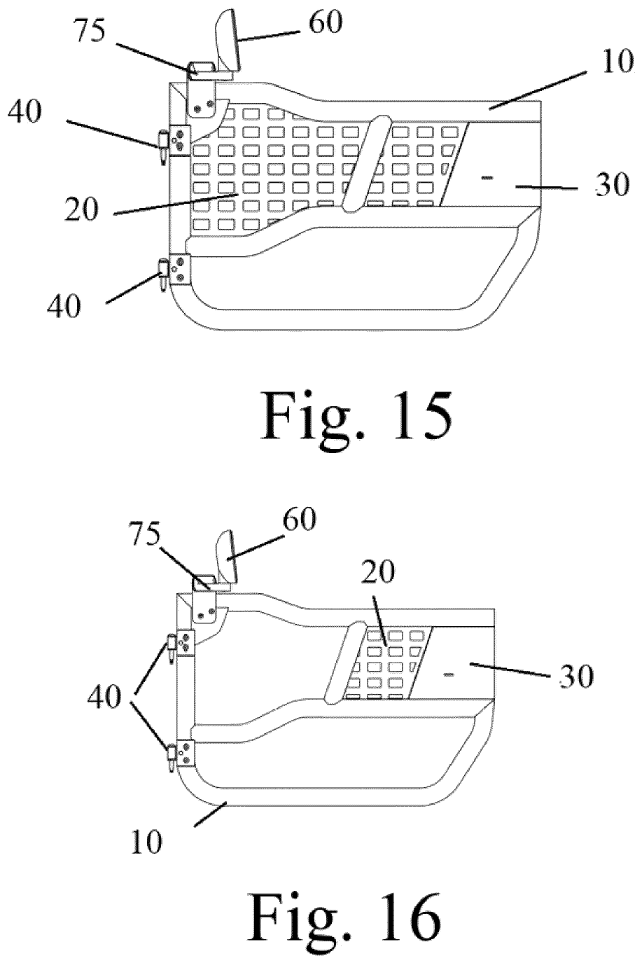

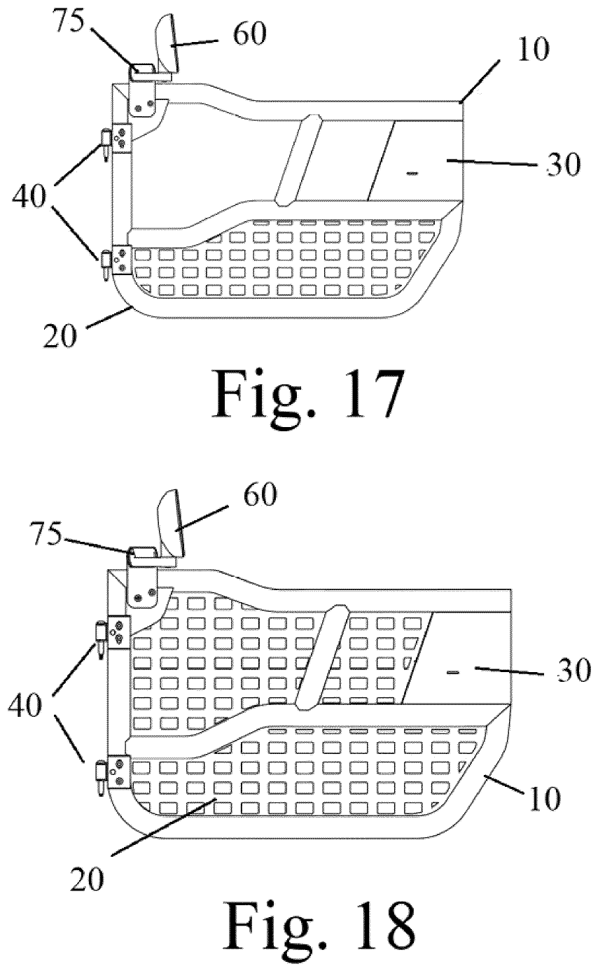

FIGS. 14, 15, 16, 17 and 18 shows the door frame 10 with different cover 20 combinations. FIG. 15 shows the door frame 10 without any covers 20. FIG. 15 shows the door frame 10 with the top half with molle panels covers 20. FIG. 16 shows the door frame 10 with a single cover 20 in the middle of the door frame 10. FIG. 17 shows the door frame 10 with only the bottom covered by the cover 20. FIG. 18 shows the door frame 10 completely covered by a molle panel cover 20.

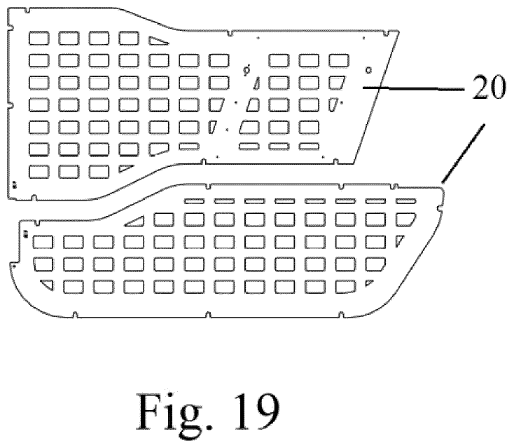

FIG. 19 shows a molle panel cover 20 for the top and the bottom of the door frame 10. The molle panel covers 20 are removable from the door frame 10 with the user having the option of placing both, one or none on the door panel 10.

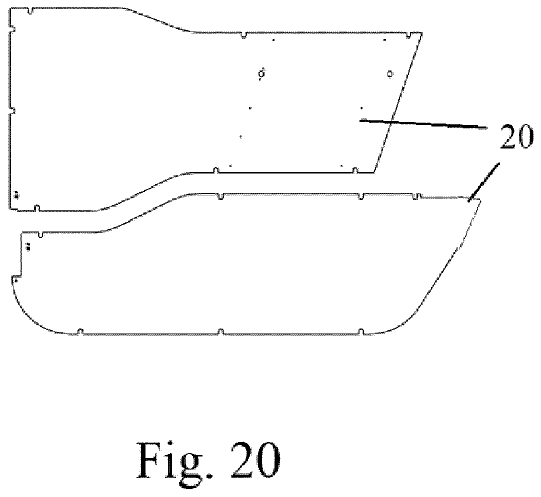

FIG. 20 shows a solid panel cover 20 for the top and the bottom of the door frame 10. The solid panel covers 20 are removable from the door frame 10 with the user having the option of placing both, one or none on the door panel 10.

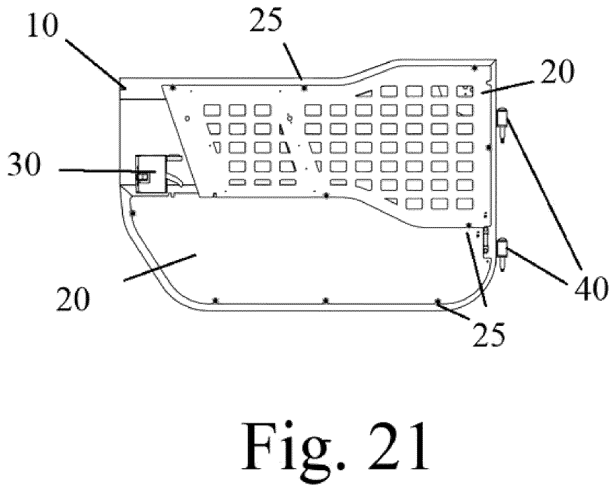

FIG. 21 shows a door panel 10 with a molle panel cover 20 on the top and a solid cover 20 on the bottom. This shows that the user can mix the type of covers that they use to cover the door panel 10.

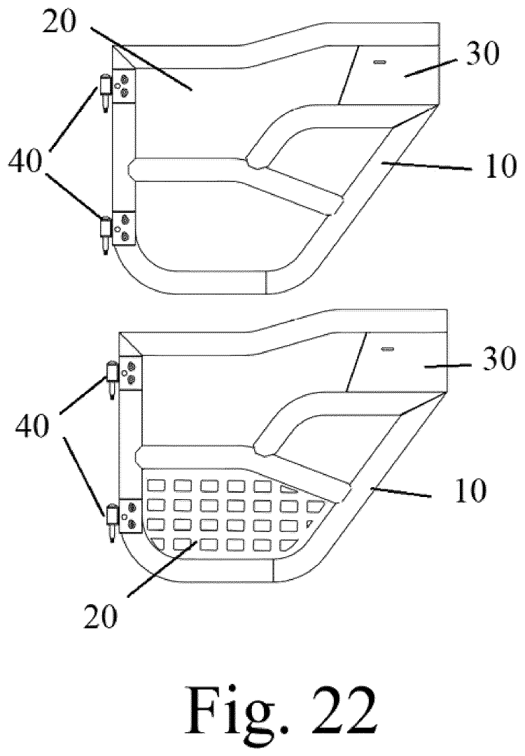

FIG. 22 shows a two views of a different shaped door panel 10 with cover 20, one with a solid cover 20 and one with a molle panel cover 20.

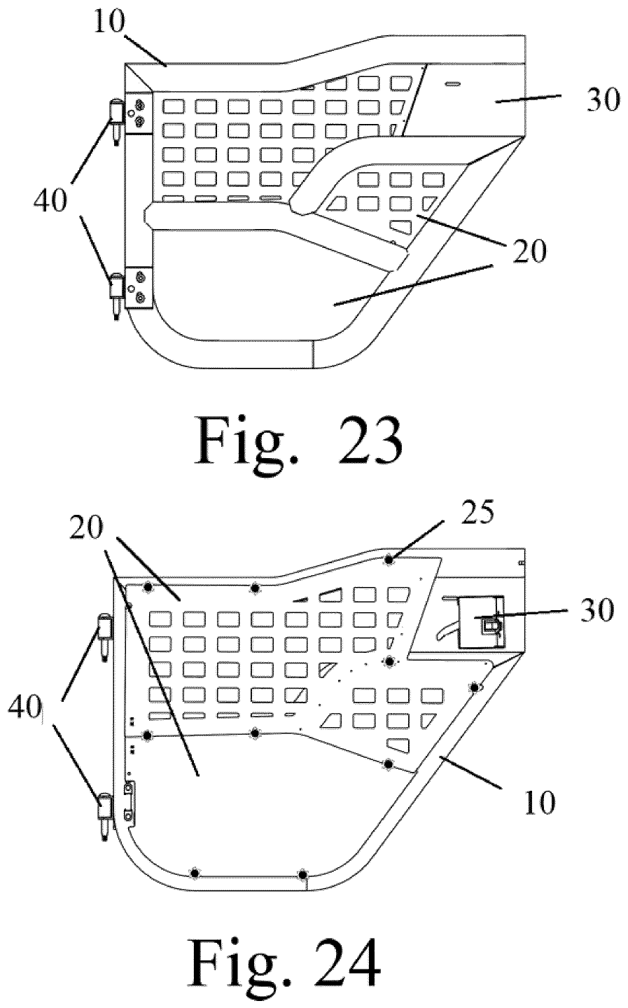

FIG. 23 shows the back view (side that faces outside of the vehicle 100) of a door frame 10 with a molle panel cover 20 on the top and a solid panel cover 20 on the bottom. FIG. 24 shows the front view (side that faces inside of the vehicle 100) of the same door frame 10. This view shows the bolts 25 that are used to connect the covers 20 to the door frame 10. These view show the removable attachment means, such as bolts 20, that attach the covers 20 to the door frame 10.

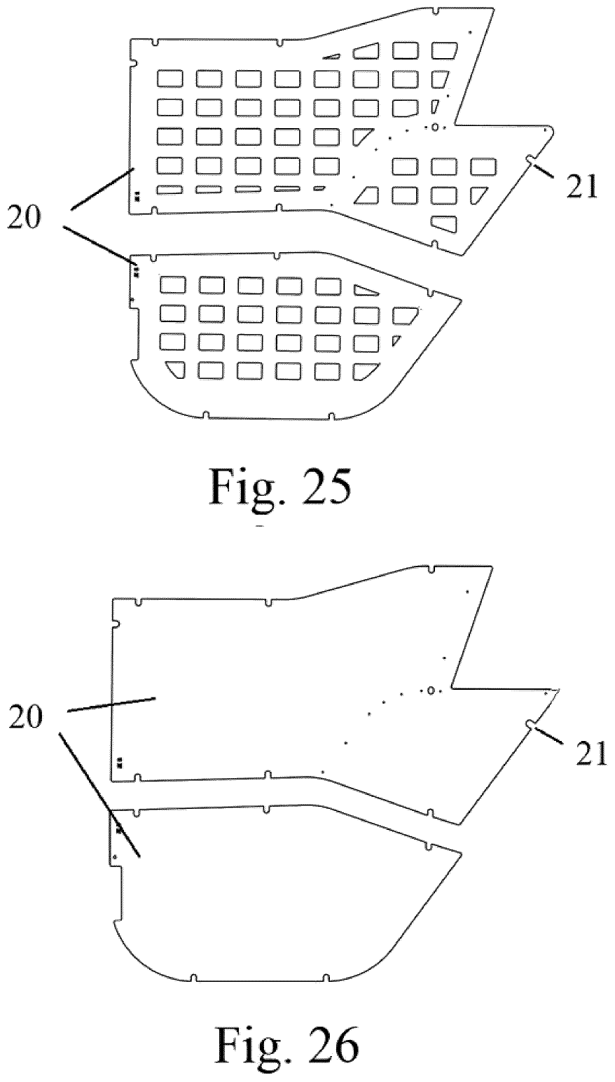

FIG. 25 shows a top and bottom molle panel cover 20. FIG. 26 shows a top and bottom solid panel cover 20. These views show nubs 21 into which bolts 25 fit. The covers 20 may also have bolt holes in them to serve the same purpose.

The covers 20 can easily be removed or connected to the door panel 10 using a connection means such as bolts 25. Multiple covers 20 and cover 20 combinations can be used or no covers can be used. It is up to what the user wants. Nets, molle panels, solid or any combination of covers 20 be used depending on the needs and desires of the user.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device comprising:
a removable jeep doorframe with a plurality of removable covers.

2. The device according to claim 1 further comprising:
having an outer frame with support bars that connect one side of the outer door frame.

3. The device according to claim 1 further comprising:
where the shape and size fit a doorframe of a vehicle.

4. The device according to claim 1 further comprising:
where the frame is cylindric, rounded pieces/tubes.

5. The device according to claim 2 further comprising:
having a plurality of pins on the front outer frame which are positioned to go into door hinges of a vehicle.

6. The device according to claim 2 further comprising:
having partial covers.

7. The device according to claim 1 further comprising:
having a latch.

8. The device according to claim 7 further comprising:
having the latch on the back side of the door frame.

9. The device according to claim 1 further comprising:
having a mirror.

10. The device according to claim 1 further comprising:
having a wind shield.

11. The device according to claim 1 further comprising:
where the covers can be made of one or more of a set of nets, molle panels, or solid panels.

12. The device according to claim 11 further comprising:
where the plurality of covers that are connected to door frame are a combination of nets, molle panels, or solid panels.

13. The device according to claim 1 further comprising:
where the plurality of covers that are connected to door frame connected by a removable connection means.

14. The device according to claim 13 further comprising:
where the removable connection means are bolts.

15. A device comprising:
a removable jeep doorframe with a plurality of removable covers, having an outer frame with support bars that connect one side of the outer door frame, having a plurality of pins on the front outer frame which are positioned to go into door hinges of a vehicle, having the latch on the back side of the door frame, where the plurality of covers that are connected to door frame connected by a removable connection means.

16. The device according to claim 15 further comprising:
where the shape and size fit a doorframe of a vehicle.

17. The device according to claim 15 further comprising:
where the frame is cylindric, rounded pieces/tubes.

18. The device according to claim 15 further comprising:
having a mirror.

19. The device according to claim 15 further comprising:
having a wind shield.

20. The device according to claim 15 further comprising:
where the covers can be made of one or more of a set of nets, molle panels, or solid panels.
